(19) United States
(12) Patent Application Publication
(10) Pub. No.: US 2005/0108441 A1
(43) Pub. Date: May 19, 2005

(54) Multimedia audio and video player device

(76) Inventor: Wei-Chi Wang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/962,503

(22) Filed: Oct. 13, 2004

(30) Foreign Application Priority Data
Nov. 14, 2003 (TW) 092131968

(51) Int. Cl. G06F 3/00

(52) U.S. Cl. 710/1

(57) ABSTRACT

A multimedia audio and video display device has a main circuit board, a multimedia disk reader and an audio and video (A/V) signal processing unit. The multimedia disk reader is connected between the main circuit board and the A/V signal processing unit and is adapted to play A/V signals of a disk. The main circuit board and the A/V signal processing unit are connected to an external display device and speakers and each of them has one independent power supply so the A/V signal processing unit can operate independently without the main circuit board. The A/V signal processing unit further has receiving and broadcasting FM signals function and playing TV signals function, so the A/V signal processing unit provides combination A/V playing capability.

### BACKGROUND OF THE INVENTION

1. Field of the Invention

The present invention relates to a multimedia audio and video (A/V) player device and more particularly to a multimedia audio and video (A/V) player device that includes a main circuit board and has an independent A/V playing capability when the main circuit board is in power off condition.

2. Description of Related Art

The present computer technology has been developed very well, so the computer product can not only be used to process electronic documents, but also can be used as an audio/video (A/V) player multimedia product. With reference to FIG. 6, a common computer product mainly comprises a main host (70), an input device (73), a display device (71) and speakers (72). The input device (73) includes a keyboard (731) and a mouse (732). Since the main host (70) has a main circuit board (not shown) at least having a central processor, a disk reader etc. Therefore, when the disk reader outputs A/V signals from a disk to the central processor, the central processor will respectively output the audio signals and video signals to the speakers (72) and display device (71). The user can watch a movie via the display device (71) and speaker (72).

When the power of the main host is turned on, the main circuit board, the display device and speaker respectively obtain the power to operate. To provide other functions the computer has be set up with other hardware elements, such as different functional hardware elements, and devices such as a printer, a scanner and a modem. Therefore, even when the computer only executes one function or program, these hardware elements and devices still consume the power. For example, if the user uses the computer to broadcast music by the disk reader and does not execute another program or function, many interface cards in the main circuit board and the display device will not work, but they are still in power on condition to consume power. Therefore, these non-operating elements and devices still consume the power, too.

Although the currently available notebook computers have an independent broadcasting music capability without starting the operation system of the main circuit board, they do not display images on the display device when the main circuit board is in power off condition. Therefore, the notebook computer does not have an independent display A/V signals capability.

To overcome the shortcomings, the present invention provides a multimedia audio and video player device to have an independent playing audio and/or video capability.

### SUMMARY OF THE INVENTION

The main objective of the present invention is to provide a multimedia A/V player device that has independent player A/V signals capability when a main circuit board is in power off condition.

The multimedia A/V player device in accordance with the present invention has a main circuit board, a multimedia disk reader and an audio and video (A/V) signal processing unit. The multimedia disk reader is connected between the main circuit board and the A/V signal processing unit and is adapted to play A/V signals of disk. The main circuit board and the A/V signal processing unit are connected to an external display device and a speaker and each of them has one independent power supply so the A/V signal processing unit can operate independently without the main circuit board. The A/V signal processing unit further has broadcasting FM signals function and playing TV signals function, so the A/V signal processing unit provides combination A/V playing functions.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a first embodiment of a multimedia audio and video (A/V) player device in accordance with the present invention;

FIG. 2 is a front side plan view of the multimedia player device in accordance with the present invention;

FIG. 3 is a rear side plan view of the multimedia player device in accordance with the present invention;

FIG. 4 is a schematic view of a display device, a speaker and the multimedia A/V player device in accordance with the present invention;

FIG. 5 is a schematic view of a display device, speakers and the multimedia A/V player device with a mouse and a keyboard in accordance with the present invention; and

FIG. 6 is a schematic view of a conventional multimedia computer in accordance with the prior art.

### DETAILED DESCRIPTION OF THE PREFERRED EMBODIMENT

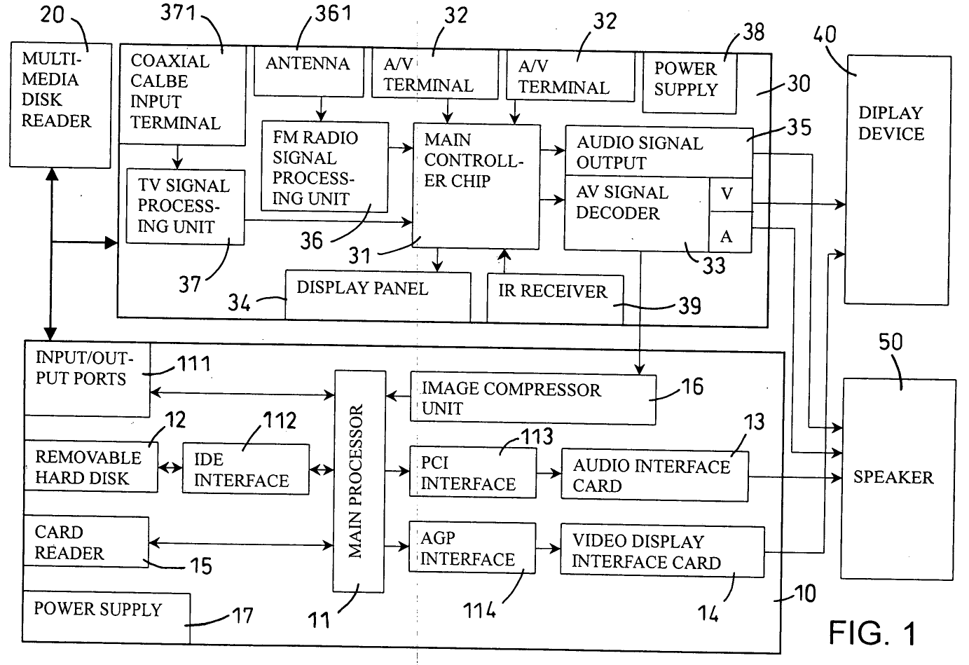

With reference to FIG. 1, a first embodiment of a multimedia player device in accordance with the present invention has a main circuit board (10), a multimedia disk reader (20) and an audio/video (A/V) signal processing unit (30). The multimedia disk reader (20) is connected between the main circuit board (10) and the A/V signal processing unit (30), and is used to play a disk (not shown) to output audio and/or video (A/V) signals.

The main circuit board (10) may be a Micro-ATX type and includes a main processor (11), multiple input and output ports (111) (such as RS232/PS2/USB2.0/IEEE1394/RJ45), multiple different type interfaces (112 to 114) (such as IDE/PCI/AGP), a removable hard disk (12), an audio interface card (13), a video display interface card (14), an optional card reader (15), an image compressor unit (16) and a power supply (17).

The multiple input and output ports (111), multiple interfaces (112 to 114), the card reader (15) and the image compressor unit (16) are respectively connected to the main processor (11). The removable hard disk (12) is connected to the main processor (11) through the IED interface (112). The audio interface card (13) is connected to the main processor (11) through the PCI interface (113) and is adapted to connect to speakers (50). The video display interface card (14) is connected to the main processor (11) through the AGP interface (114) and is adapted to connect to a display device (40).

The main processor (11) controls the multimedia disk reader (20) to read the A/V signals from the disk (not shown) and then outputs the A/V signals to the display device (40) and the speakers (50) through the audio interface card (13) and the video display interface card (14). The power supply (17) has a power button (not shown) to turn on or off the power supply.

The A/V signal processing unit (30) has a main controller chip (31), multiple different type A/V terminals (32) (such as DVI, S/V etc.), an A/V signal decoder (33), a display panel (34), an optional audio signal output (35), an optional FM radio signal processing unit (36), an optional TV signal processing unit (37), a power supply (38) and an optional infrared (IR) receiver (39). The power supply (38) has a power button (not shown) to turn on or off the power supply (38).

The main controller chip (31) is connected to the multiple A/V terminals (32), the A/V signal decoder (33), the display panel (34) and the audio signal output (35), the FM radio signal processing unit (36) and a TV signal processing unit (37). The A/V terminals (32) are used to respectively connect to an external AV player product (not shown). The A/V signal decoder (33) is adapted to connect to the display device (40) and the speakers (50); The audio signal output (35) is adapted to connect to the speakers (50). The A/V signal decoder (33) is connected to the image compressor unit (16) of the main circuit board (10).

The FM radio signal processing unit (36) is connected to an antenna (361) to receive FM radio signals in different frequencies. Therefore, the main controller chip (31) controls the FM radio signal processing unit (36) to receive FM radio signals through the antenna (361) and then outputs the FM radio signals to the speakers (50) through the audio signal output (35). The speakers (50) will broadcast the FM radio signals. The TV signal processing unit (37) has a coaxial cable input terminal (371) adapted to connect to an external coaxial cable (not shown). When the coaxial cable transmits TV signals to the coaxial cable input terminal (371), the TV signal processing unit (37) receives the TV signals through the coaxial cable input terminal (371). The main controller chip (31) will output the TV signals to the display device (40) and the speakers (50) through the A/V signal decoder (33).

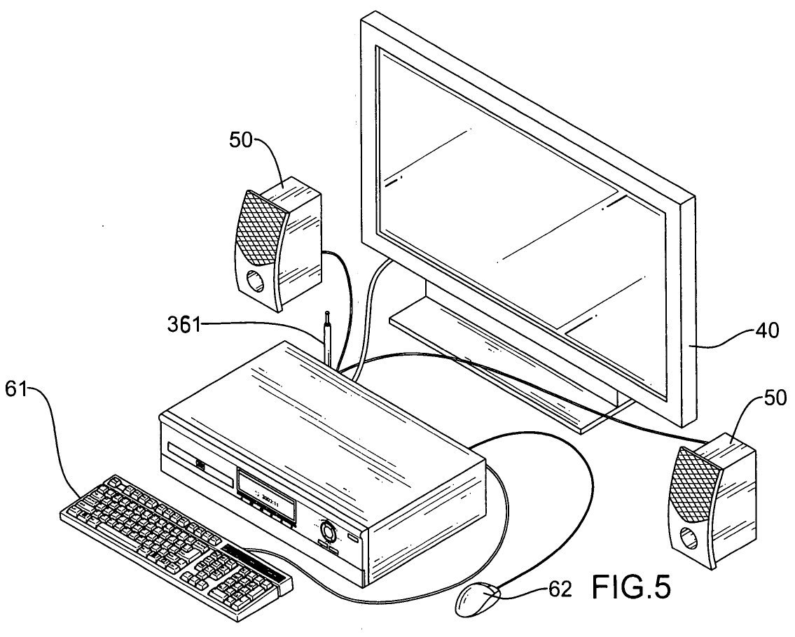

Since the display panel (34) is connected to main controller chip (31), the display panel (34) is used to display the receiving frequency, or times of playing A/V signals or TV channel number according to which function is determined by the user. The IR receiver (39) is adapted to receive IR remote signals from an IR remote control (60) to control operation of the main circuit board (10) or the A/V signal processing unit (30), as shown in FIGS. 1 and 4.

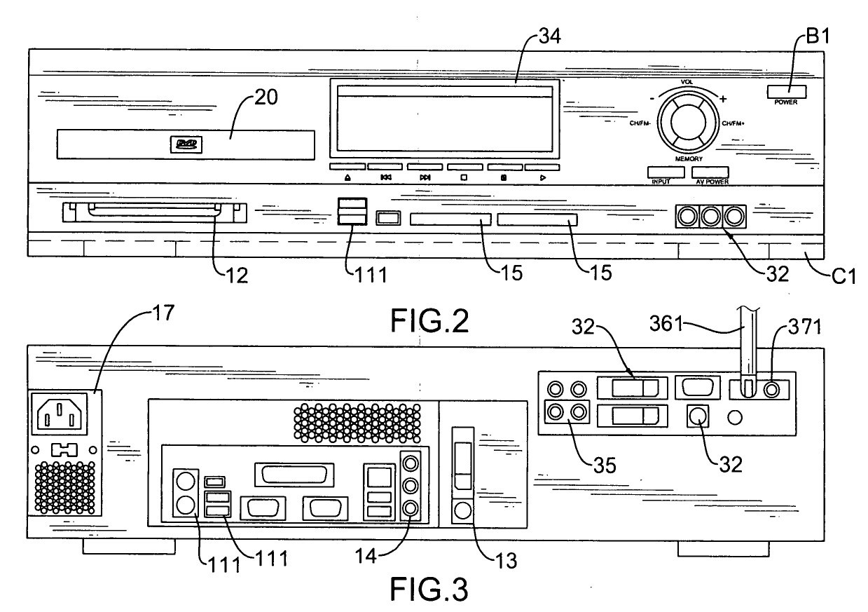

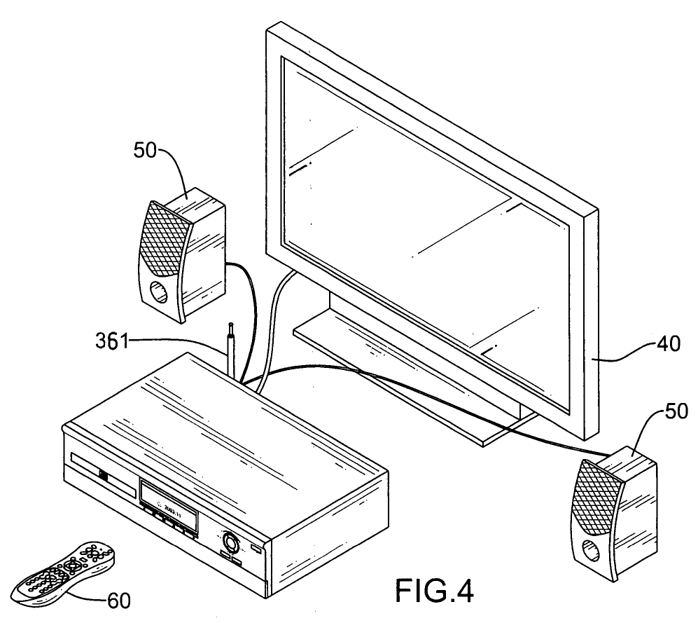

With reference to FIGS. 2 and 3, a front side and a rear side of a preferred embodiment of an outline of the present invention is disclosed. The display panel (34), multimedia disk reader (20), input and output ports (111), a removable hard disk (12), the card reader (15), the A/V terminals (32) and many functional buttons are formed on the front side of the outline. The functional buttons include the two power buttons (B1, B2) of the two power supplies. Since the card reader (15), the removable hard disk (12), the A/V terminals (32) and input and output ports (111) are not usually used, so the front side has a cover (C1) to cover these element and provides a dust-proof function. With reference to FIG. 3, the A/V terminal (32), the audio signal output (35), the cable input terminal (371), the audio signal interface card (13), the video display interface card (14) and input and output ports (111) are formed on the rear side.

With reference to FIG. 4, the multimedia player device is connected to the display device (40) and the speakers (50). The IR remote control (60) can control the operation of the multimedia device to display images or broadcast the audio signals.

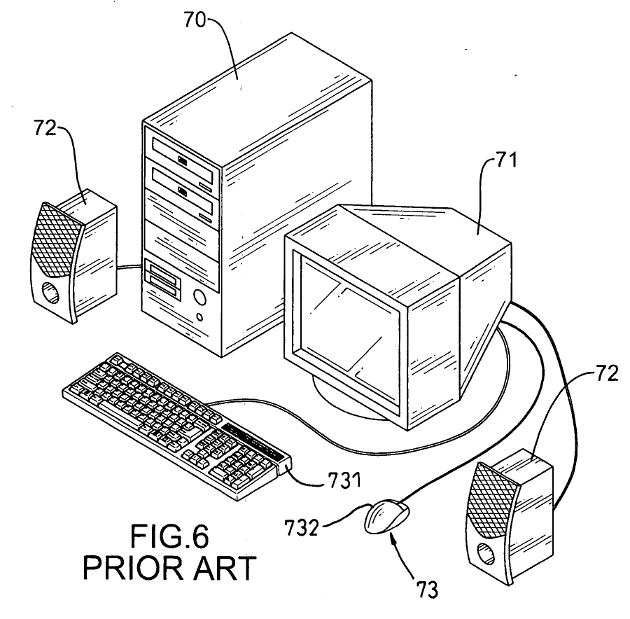

With reference to FIG. 1, the present invention mainly provides two independent power supplies (17, 38) respectively connected to the main circuit board (10) and the A/V signal processing unit (30) to provide power to all elements of the main circuit board (10) and the A/V signal processing unit (30). When the power supply (38) of the A/V processing unit (30) is turned on and the power supply (17) of the main circuit board (10) is turned off, the user can determine one of the functions of the A/V processing unit (30), that includes broadcasting the FM radio signals, playing the A/V signals of the disk and playing the TV signals functions. Therefore, in the main circuit board (10) shut down condition the present invention still provides playing of A/V signals and TV signals and receiving and broadcasting the FM radio signals functions unless the user would like to store the A/V signals and edit them. That is, with reference to FIGS. 1, 3 and 5, a mouse (62) and a keyboard (61) are prepared to connect to the input and output ports (111) of the main circuit board (10) and then the power supply (17) of the main circuit board (10) is turned on. The image compressor unit (16) is controlled by the main processor (11) to receive the A/V signals from the A/V signal decoder (33). The main processor (11) can edit or store the compressed A/V signals in the removable hard disk (12).

Based on the forgoing description, the present invention provides an independent broadcasting A/V signals capability without operation of the main circuit board. When the A/V signal processing unit is operating the user can select to broadcast A/V signals of the multimedia disk, TV signals or FM radio signals. If the user would like to edit or store the A/V signals or TV signals, only the mouse and keyboard need be prepared and then the power is supplied. Therefore, the present invention combines the functions of DVD player, hi-fi equipment, radio and computer products.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A multimedia audio and video (A/V) play device, comprising:
a main circuit board having a main processor, multiple input and output ports, multiple different type interfaces, a hard disk, an audio interface card, a video display interface card, an image compressor unit and a power supply, wherein the multiple input and output ports, the multiple interfaces, the audio interface card, the video display interface card, the image compressor unit and the power supply are respectively connected to the main processor, wherein the power supply provides power to all elements of the main circuit board;
an audio/video (A/V) signal processing unit having a main controller chip, multiple different type A/V terminals, an A/V signal decoder, a display panel, an audio signal output and a power supply, wherein the main controller chip is connected to the multiple A/V terminals, the display panel, the audio signal output, the power supply and the A/V signal decoder, that is adapted to connect to the display device and the speaker, and is connected to the image compressor unit of the main circuit board, wherein the power supply provides power to all elements of the A/V signal processing unit; and
a multimedia disk reader connected between the main circuit board and the A/V signal processing unit to play a disk and output audio and/or video signals.

2. The multimedia A/V play device as claimed in claim 1, wherein main controller chip is further connected to an FM radio signal processing unit connected to an antenna to receive FM radio signals in different frequencies, wherein the main controller chip outputs the FM radio signals to the speakers through the audio signal output when the main controller chip receives the FM radio signals from the FM radio signal processing unit.

3. The multimedia A/V play device as claimed in claim 1, wherein the main controller chip is further connected to a TV signal processing unit having a coaxial cable input terminal, which is adapted to connect to a coaxial cable for transmitting TV signals, wherein the main controller chip outputs the TV signals to the display device through the A/V signal decoder, when the main controller chip receives the TV signals from the TV signal processing unit.

4. The multimedia A/V play device as claimed in claim 2, wherein the main controller chip is further connected to a TV signal processing unit having a coaxial cable input terminal, which is adapted to connect to a coaxial cable for transmitting TV signals, wherein the main controller chip outputs the TV signals to the display device through the A/V signal decoder, when the main controller chip receives the TV signals by the TV signal processing unit.

5. The multimedia A/V play device as claimed in claim 1, wherein the main controller chip is further connected to an IR receiver to receive IR signals from an IR remote control.

6. The multimedia A/V play device as claimed in claim 2, wherein the main controller chip is further connected to an IR receiver to receive IR signals from an IR remote control.

7. The multimedia A/V play device as claimed in claim 1, wherein the multiple input and output ports comprises RS232, PS2, USB2.0, IEEE1394 and RJ45 ports.

8. The multimedia A/V play device as claimed in claim 1, wherein the multiple interfaces comprises IDE, PCI and AGP interfaces, wherein the IDE interface is connected between the main processor and the hard disk, the PCI interface is connected between the main processor and the audio interface card, and the AGP interface is connected between the main processor and the video display interface card.

9. The multimedia A/V play device as claimed in claim 1, wherein the hard disk is a removable hard disk.
